(19) United States
(12) Patent Application Publication
(10) Pub. No.: US 2011/0167362 A1
(43) Pub. Date: Jul. 7, 2011

(54) CUSTOMIZING AT LEAST ONE COMPUTER SOFTWARE APPLICATION FOR AT LEAST ONE USER BASED ON DATA ASSOCIATED WITH THE USER

(75) Inventor: Jeffrey W. Nichols, San Jose, CA (US)

(73) Assignee: International Business Machines Corporation, Armonk, NY (US)

(21) Appl. No.: 12/609,861

(22) Filed: Jan. 7, 2010

(51) Int. Cl. G06F 3/01; G06F 9/44

(52) U.S. Cl. 715/762; 717/168

(57) ABSTRACT

The present invention provides a processor-implemented method and system of customizing at least one computer software application for at least one user based on data associated with the user. In an exemplary embodiment, the method and system include, (1) allowing the user to specify the data, (2) permitting the user to associate the data with at least one field in the application, and (3) letting the user change the structure of the application based on at least one preference value stored in at least one preference database. In an exemplary embodiment, the method and system include (1) allowing the user to specify the data, (2) permitting the user to associate the data with at least one field in the application, and (3) letting the user change the content of the application based on at least one preference value stored in at least one preference database.

### FIELD OF THE INVENTION

The present invention relates to computer systems, and particularly relates to a processor-implemented method and system of customizing at least one computer software application for at least one user based on data associated with the user.

### BACKGROUND OF THE INVENTION

A computer software user interface may be designed for a large number of users. Thus, such an interface would have to accommodate many features that are not relevant to all of the users. Furthermore, such a user interface typically would be unaware of facts associated with a current user of the interface. Even if the interface were aware of some facts about the user, it would be difficult and time consuming for a designer of the interface to create an interface that adapts appropriately depending on the information that the interface would have about the user. In addition, the appropriate adaptation to apply could differ for each user, further complicating the task for the user interface designer.

### PRIOR ART SYSTEMS

One prior art system allows for the auto-completion of form fields in a user interface. Referring to FIG. 1A, a prior art system includes an application with auto completion 112, where the application obtains a requested page and outputs a page with fields completed. The fields are completed either with guessed values or with values selected by the user from a list of possible values. This prior art system requires the user to attend to the fields either (i) to check that the guessed values are correct or (ii) to pick from the list of possible values.

Another prior art system is a customized application. Referring to FIG. 1B, a prior art system includes a customized application 122, where the application obtains a requested page and modifies the page based pre-set values in the application, where the values were not entered and not related to the user of the application.

Therefore, a processor-implemented method and system of customizing at least one computer software application for at least one user based on data associated with the user, is needed.

### SUMMARY OF THE INVENTION

The present invention provides a processor-implemented method and system of customizing at least one computer software application for at least one user based on data associated with the user. In an exemplary embodiment, the method and system include, (1) allowing the user to specify the data, (2) permitting the user to associate the data with at least one field in the application, and (3) letting the user change the structure of the application based on at least one preference value stored in at least one preference database. In an exemplary embodiment, the method and system include (1) allowing the user to specify the data, (2) permitting the user to associate the data with at least one field in the application, and (3) letting the user change the content of the application based on at least one preference value stored in at least one preference database.

In an exemplary embodiment, the allowing includes allowing the user to set the value in the database. In an exemplary embodiment, the allowing includes allowing the user to set the value while interacting with at least one content page associated with the application. In an exemplary embodiment, the allowing includes allowing the user to set the value via an interface to a customization application in a customization system.

In an exemplary embodiment, the letting includes (a) identifying at least one content page associated with the application, (b) searching the database for at least one related value that is related to the page, thereby resulting in at least one found value, (c) inserting the found value into the page, and (d) removing the page based on the found value. In an exemplary embodiment, the letting includes (a) identifying at least one content page associated with the application, (b) searching the database for at one least related value that is related to the page, thereby resulting in at least one found value, (c) inserting the found value into the page, and (d) splitting the page into at least two other content pages based on the found value. In an exemplary embodiment, the letting includes (a) identifying at least one content page associated with the application, (b) searching the database for at least one related value that is related to the page, thereby resulting in at least one found value, (c) inserting the found value into the page, and (d) combining the page with at least one other content page based on the found value.

In an exemplary embodiment, the permitting includes permitting the user to make the application avoid displaying at least one field that is associated with the value. In an exemplary embodiment, the letting includes (a) identifying at least one content page associated with the application, (b) searching the database for at least one related value that is related to the page, thereby resulting in at least one found value, (c) inserting the found value into the page, and (d) removing at least one designated field on the page based on the found value.

The present invention also provides a computer program product usable with a programmable computer having readable program code embodied therein of customizing at least one computer software application for at least one user based on data associated with the user. In an exemplary embodiment, the computer program product includes (1) computer readable code for allowing the user to specify the data, (2) computer readable code for permitting the user to associate the data with at least one field in the application, and (3) computer readable code for letting the user change the structure of the application based on at least one preference value stored in at least one preference database.

### THE FIGURES

FIG. 1A is a diagram of a prior art technique.

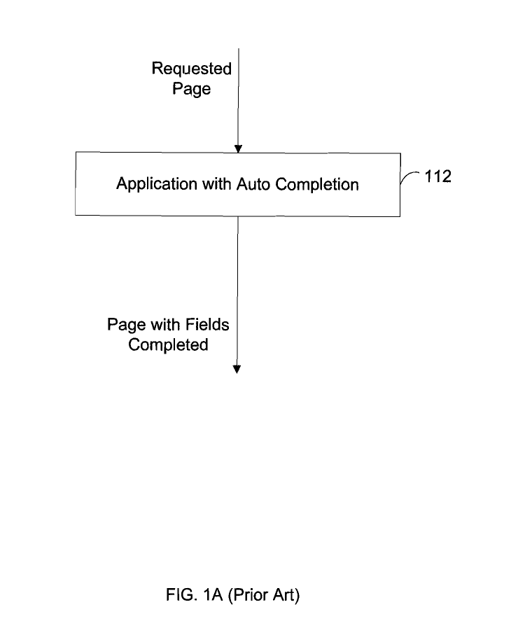

FIG. 1B is a diagram of a prior art technique.

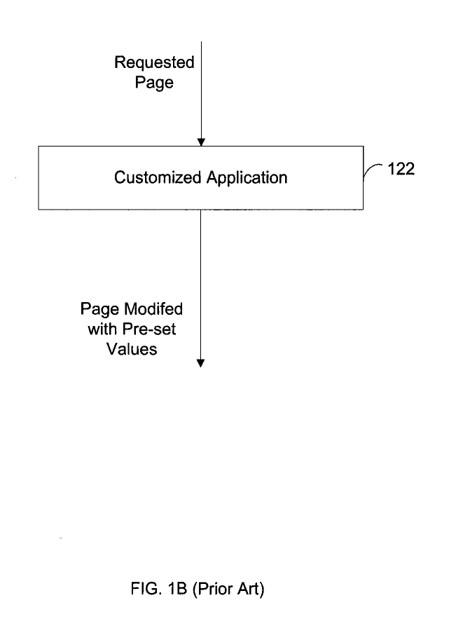

FIG. 2A is a flowchart in accordance with an exemplary embodiment of the present invention.

FIG. 2B is a diagram in accordance with an exemplary embodiment of the present invention.

FIG. 3A is a flowchart of the allowing step in accordance with an exemplary embodiment of the present invention.

FIG. 3B is a flowchart of the allowing step in accordance with an exemplary embodiment of the present invention.

FIG. 3C is a flowchart of the allowing step in accordance with an exemplary embodiment of the present invention.

FIG. 4A is a flowchart of the letting step in accordance with an exemplary embodiment of the present invention.

FIG. 4B is a flowchart of the letting step in accordance with an exemplary embodiment of the present invention.

FIG. 4C is a flowchart of the letting step in accordance with an exemplary embodiment of the present invention.

FIG. 5A is a flowchart in accordance with an exemplary embodiment of the present invention.

FIG. 5B is a diagram in accordance with an exemplary embodiment of the present invention.

FIG. 6A is a flowchart of the allowing step in accordance with an exemplary embodiment of the present invention.

FIG. 6B is a flowchart of the allowing step in accordance with an exemplary embodiment of the present invention.

FIG. 6C is a flowchart of the allowing step in accordance with an exemplary embodiment of the present invention.

FIG. 7 is a flowchart of the permitting step in accordance with an exemplary embodiment of the present invention.

FIG. 8 is a flowchart of the letting step in accordance with an exemplary embodiment of the present invention.

### DETAILED DESCRIPTION OF THE INVENTION

The present invention provides a processor-implemented method and system of customizing at least one computer software application for at least one user based on data associated with the user. In an exemplary embodiment, the method and system include, (1) allowing the user to specify the data, (2) permitting the user to associate the data with at least one field in the application, and (3) letting the user change the structure of the application based on at least one preference value stored in at least one preference database. In an exemplary embodiment, the method and system include (1) allowing the user to specify the data, (2) permitting the user to associate the data with at least one field in the application, and (3) letting the user change the content of the application based on at least one preference value stored in at least one preference database. In an exemplary embodiment, the present invention is implemented as a second set of transformation algorithms separate from the transformations already in a proxy computer server.

### Changing the Structure of the Application

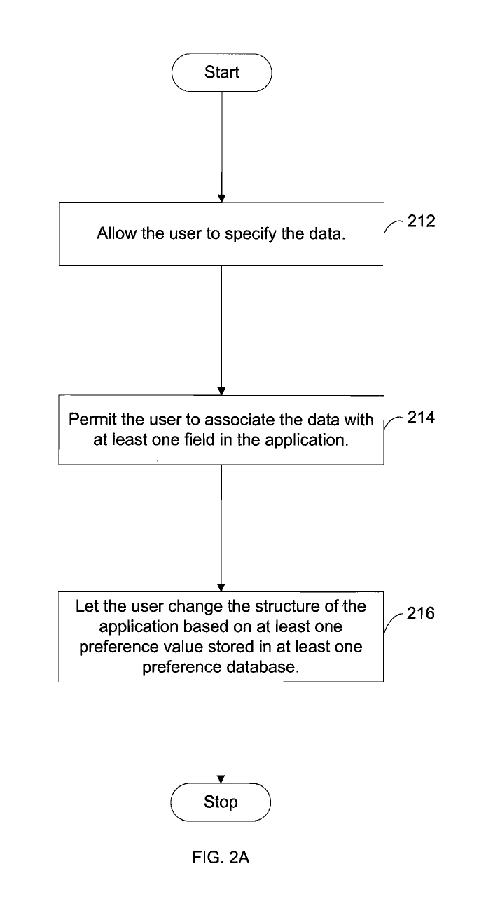

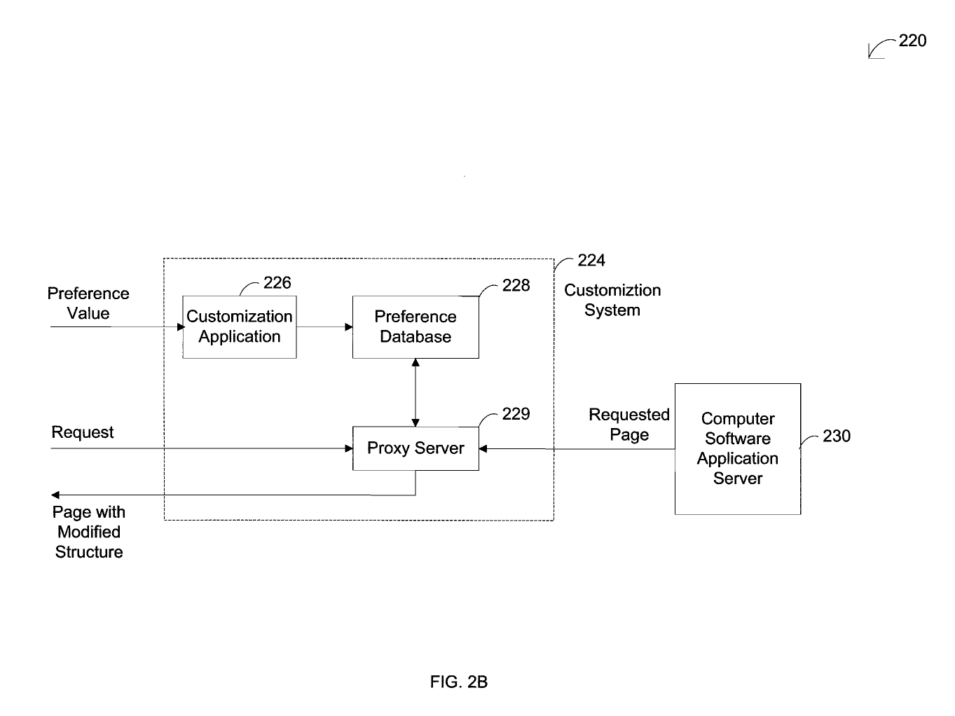

Referring to FIG. 2A, in an exemplary embodiment, the present invention includes a step 212 of allowing the user to specify the data, a step 214 of permitting the user to associate the data with at least one field in the application, and a step 216 of letting the user change the structure of the application based on at least one preference value stored in at least one preference database. For example, if the application were an electronic commerce application, via the invention, the user could create a desired interface to the application from the existing interface to the application by (a) specifying login information to a customization system and (b) indicating that the user is no longer interested in seeing a particular page or particular pages (e.g., the login page, the shipping/billing confirmation page, optional pages for changing information) (i) by using the application for its intended purpose or (ii) via a customization application in the customization system.

Referring to FIG. 2B, in an exemplary embodiment, user enters at least one preference value into a customization system 224. In an exemplary embodiment, customization system 224 includes a customization application 226, a preference database 228, and a proxy server 229. Specifically, the user enters at least one preference value into customization application 226. Customization application 226 then stores the preference value in preference database 228.

Via the invention, the user submits a request for a page to customization system 224. Specifically, the user submits the request to proxy server 229. Then, customization system 224 obtains the requested page from a computer software application server 230. Specifically, proxy server 229 (i) acquires the requested page from computer software application server 230, (ii) obtains preference values from the requested page, (iii) stores the obtained preference values in preference database 228, (iv) modifies the structure of the page with respect to preference values in preference database 228, and (v) outputs the page with modified structure.

Allowing

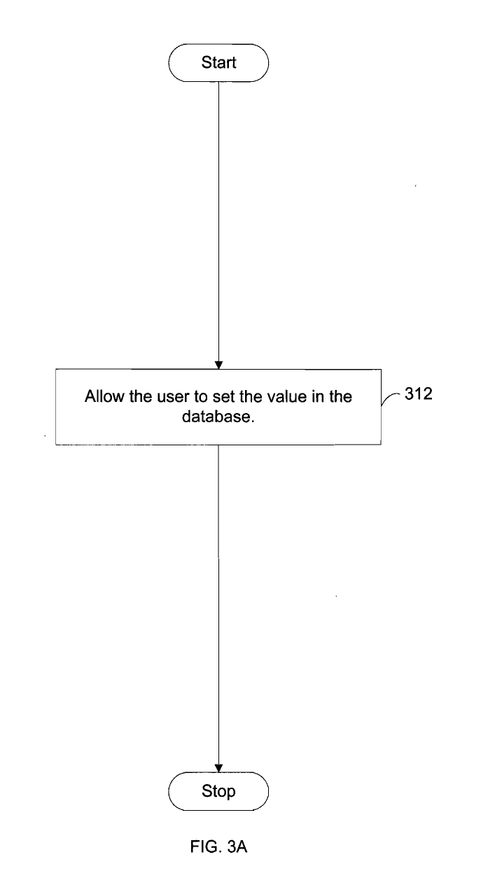

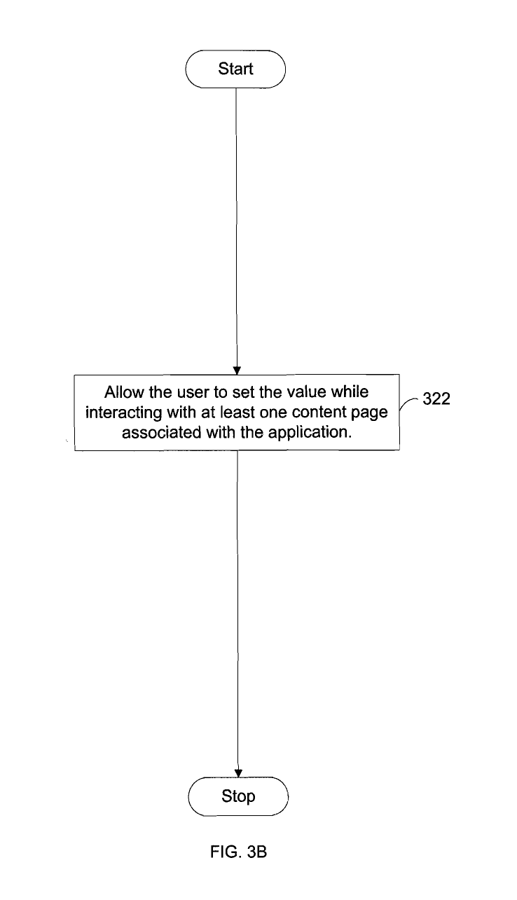

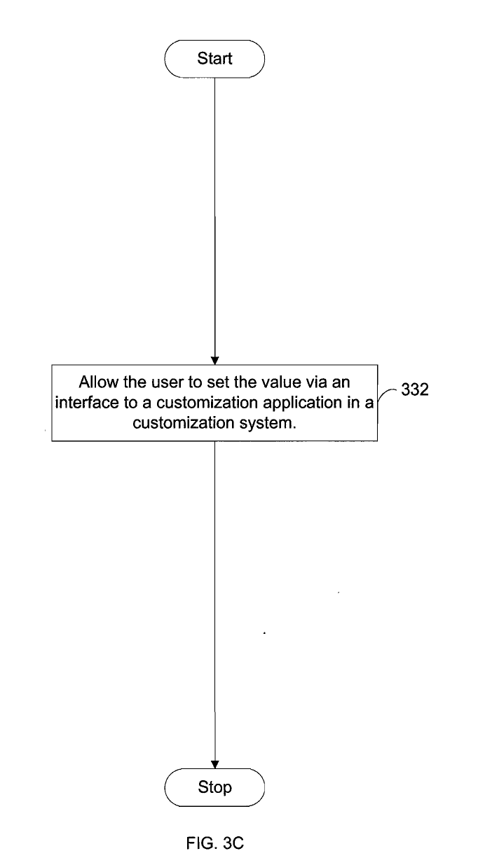

Referring to FIG. 3A, in an exemplary embodiment, allowing step 212 includes a step 312 of allowing the user to set the value in the database. Referring to FIG. 3B, in an exemplary embodiment, allowing step 312 further includes a step 322 of allowing the user to set the value while interacting with at least one content page associated with the application. For example, the user may indicate preferences (i.e., preference values) while explicitly interacting with content, on the page, that has been transformed through a proxy server. Subsequently, such preferences would be saved by preference-based algorithms for future sessions.

Referring to FIG. 3C, in an exemplary embodiment, allowing step 312 further includes a step 332 of allowing the user to set the value via an interface to a customization application in a customization system. For example, the user may (i) login to a customization system, where the customization system includes a proxy server, a preference database, and a customization application, and (ii) set preference values directly through a web interface. Such preferences would then be determined by inspecting the descriptions of the different transformation processes that are available on the proxy server and previous executions of those processes by the user or by other users.

In an exemplary embodiment, allowing step 312 further includes a step of allowing the user to provide at least one label for a plurality of preference values. For example, via the invention, another application or a user could provide high-level labels for preference values that the application or user specifies, respectively. Specifically, when entering an address (i.e., a preference value) in a field of an application, the user could indicate that the address is their “home address”. In addition, the other application might also specify that the value that should go in the application field is a “home address”. When using the application, if a preference value exists for the application field, then invention could offer the preference value as a suggestion to the user.

Letting

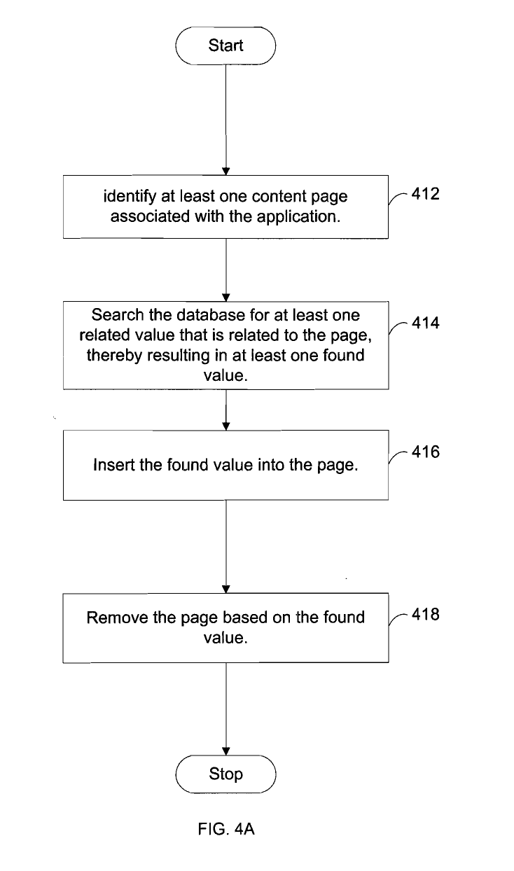

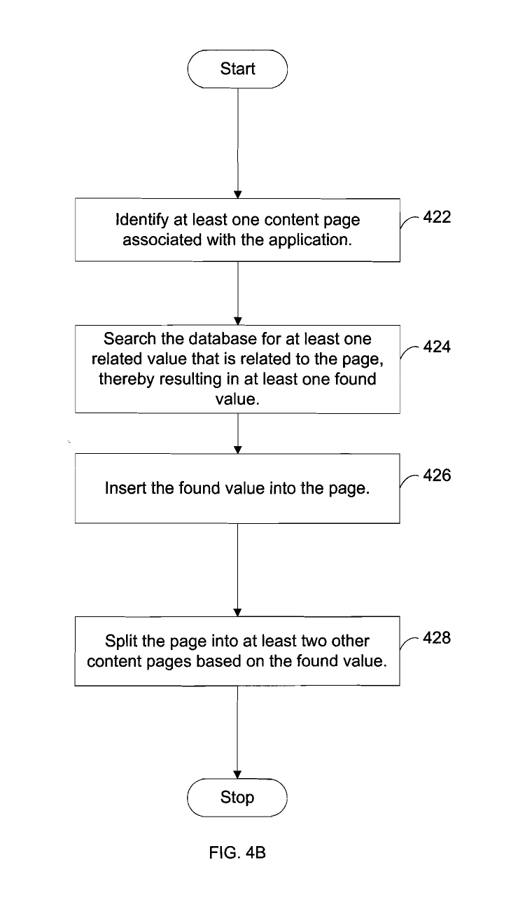

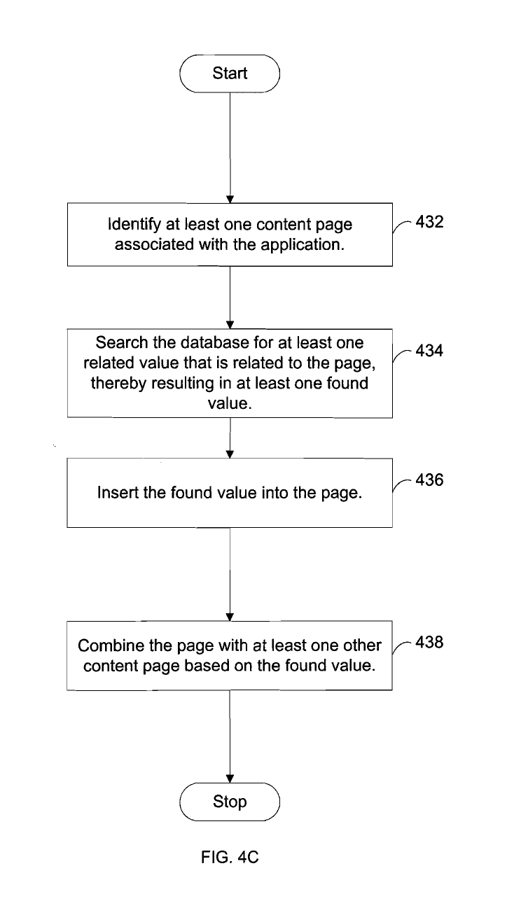

Referring to FIG. 4A, in an exemplary embodiment, letting step 216 includes a step 412 of identifying at least one content page associated with the application, a step 414 of searching the database for at least one related value that is related to the page, thereby resulting in at least one found value, a step 416 of inserting the found value into the page, and a step 418 of removing the page based on the found value.

Referring to FIG. 4B, in an exemplary embodiment, letting step 216 includes a step 422 of identifying at least one content page associated with the application, a step 424 of searching the database for at least one related value that is related to the page, thereby resulting in at least one found value, a step 426 of inserting the found value into the page, and a step 428 of splitting the page into at least two other content pages based on the found value.

Referring to FIG. 4C, in an exemplary embodiment, letting step 216 includes a step 432 of identifying at least one content page associated with the application, a step 434 of searching the database for at least one related value that is related to the page, thereby resulting in at least one found value, a step 436 of inserting the found value into the page, and a step 438 of combining the page with at least one other content page based on the found value.

For example, the invention would pass content on a content page to preference-based content transformation algorithms of the invention. The invention would then identify the content page and search the preference database for information related to the page. If any default values were found in the database, the invention would automatically insert them into the page. If the user had indicated that the user no longer wanted to see the page, then the invention would construct a web request based on the content on the page and return it to existing transformation algorithms. Via the invention, the existing transformation algorithms would observe that the user had interacted with the page and had returned some values, while in fact, the user would not have seen the current version of the page. In this way, the invention, via the preference-based transformation algorithms, could modify the structure of an application (e.g., a web site) that the user wants to see.

### Changing the Content of the Application

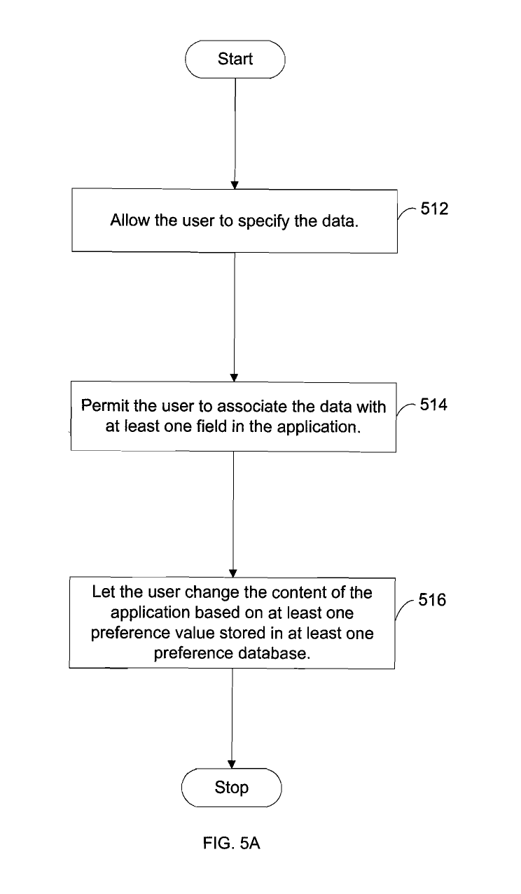

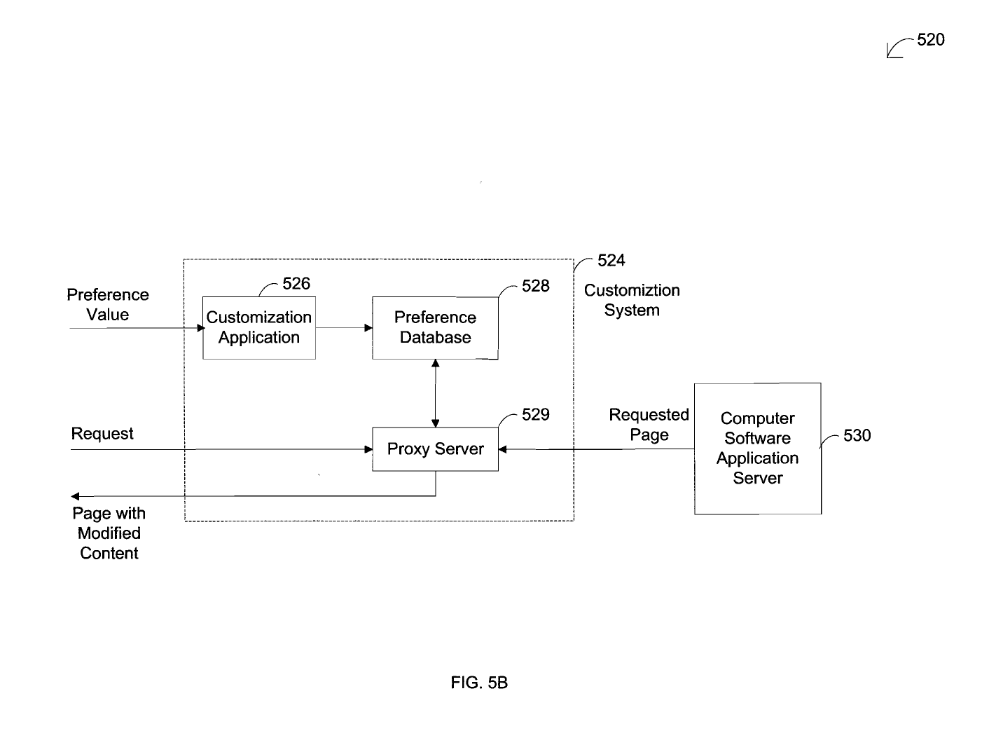

Referring to FIG. 5A, in an exemplary embodiment, the present invention includes a step 512 of allowing the user to specify the data, a step 514 of permitting the user to associate the data with at least one field in the application, and a step 516 of letting the user change the content of the application based on at least one preference value stored in at least one preference database. For example, if the application were an electronic commerce application, via the invention, the user could create a desired interface to the application from the existing interface to the application by (a) specifying login information to a customization system and (b) indicating that the user is no longer interested in seeing a particular page or particular pages (e.g., the login page, the shipping/billing confirmation page, optional pages for changing information) (i) by using the application for its intended purpose or (ii) via a customization application in the customization system.

Referring to FIG. 5B, in an exemplary embodiment, a user enters at least one preference value into a customization system 524. In an exemplary embodiment, customization system 524 includes a customization application 526, a preference database 528, and a proxy server 529. Specifically, the user enters at least one preference value into customization application 526. Customization application 526 then stores the preference value in preference database 528.

Via the invention, the user submits a request for a page to customization system 524. Specifically, the user submits the request to proxy server 529. Then, customization system 524 obtains the requested page from a computer software application server 530. Specifically, proxy server 529 (i) acquires the requested page from computer software application server 530, (ii) obtains preference values from the requested page, (iii) stores the obtained preference values in preference database 528, (iv) modifies the content of the page with respect to preference values stored in preference database 528, and (v) outputs the page with modified content.

Allowing

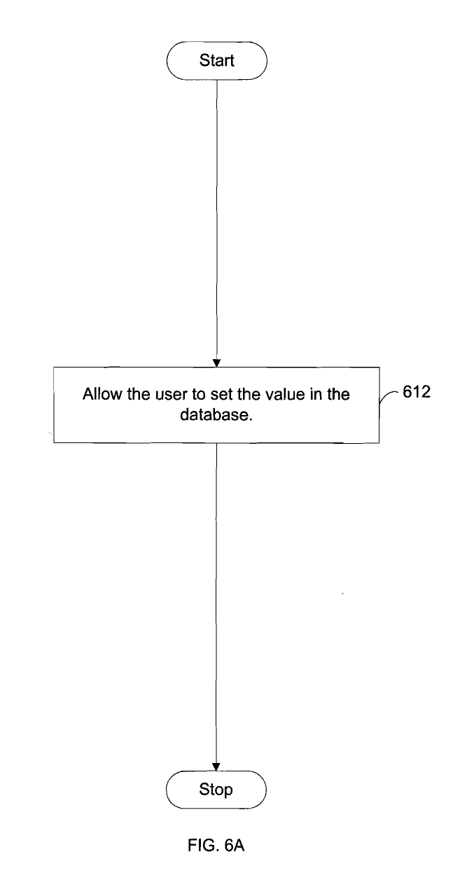

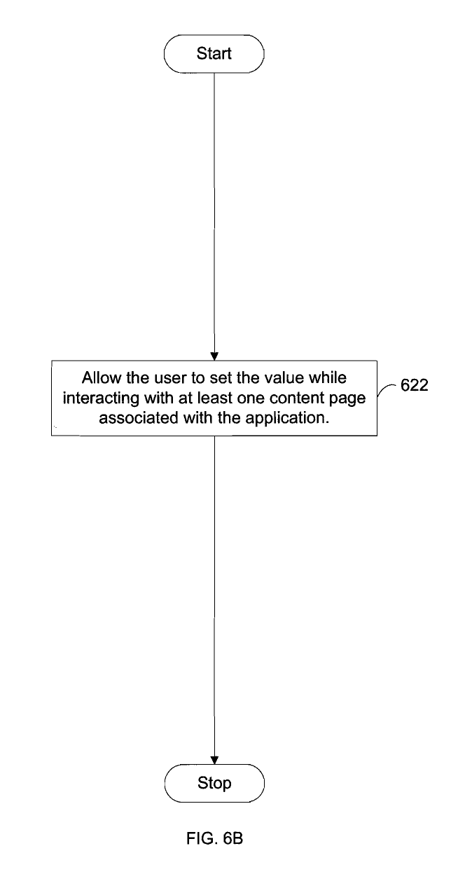

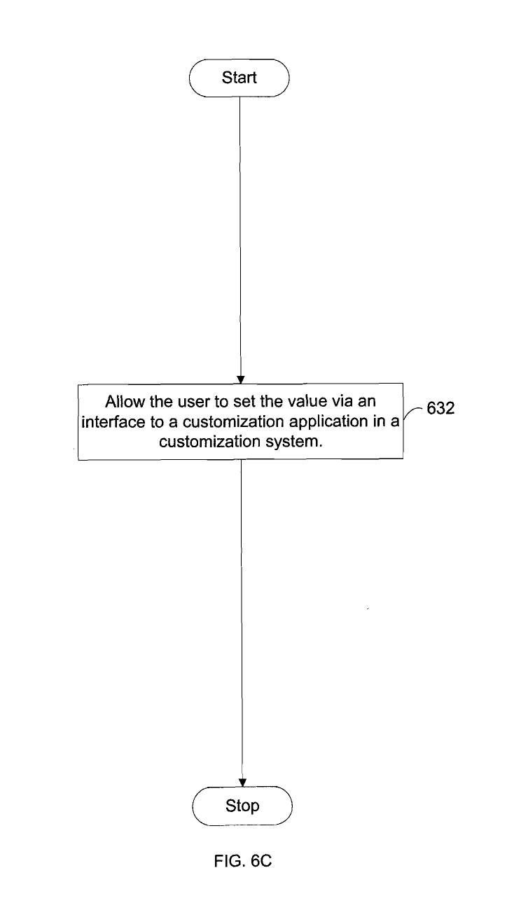

Referring to FIG. 6A, in an exemplary embodiment, allowing step 512 includes a step 612 of allowing the user to set the value in the database. Referring to FIG. 6B, in an exemplary embodiment, allowing step 612 further includes a step 622 of allowing the user to set the value while interacting with at least one content page associated with the application. For example, the user may indicate preferences (i.e., preference values) while explicitly interacting with content, on the page, that has been transformed through a proxy server. Subsequently, such preferences would be saved by preference-based algorithms for future sessions.

Referring to FIG. 6C, in an exemplary embodiment, allowing step 612 further includes a step 632 of allowing the user to set the value via an interface to a customization application in a customization system. For example, the user may (i) login to a customization system, where the customization system includes a proxy server, a preference database, and a customization application, and (ii) set preference values directly through a web interface. Such preferences would then be determined by inspecting the descriptions of the different transformation processes that are available on the proxy server and previous executions of those processes by the user or by other users.

In an exemplary embodiment, allowing step 612 further includes a step of allowing the user to provide at least one label for a plurality of preference values. For example, via the invention, another application or a user could provide high-level labels for preference values that the application or user specifies, respectively. Specifically, when entering an address (i.e., a preference value) in a field of an application, the user could indicate that the address is their “home address”. In addition, the other application might also specify that the value that should go in the application field is a “home address”. When using the application, if a preference value exists for the application field, then invention could offer the preference value as a suggestion to the user.

Permitting

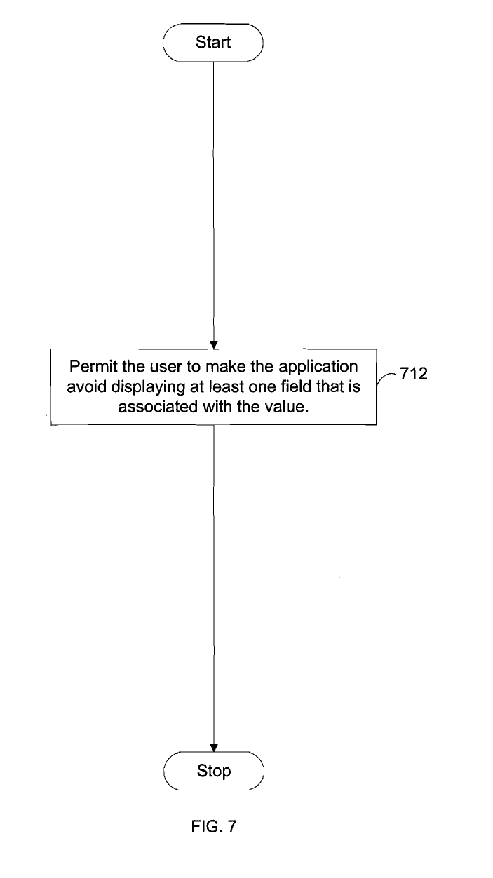

Referring to FIG. 7, in an exemplary embodiment, permitting step 514 includes a step 712 of permitting the user to make the application avoid displaying at least one field that is associated with the value.

Letting

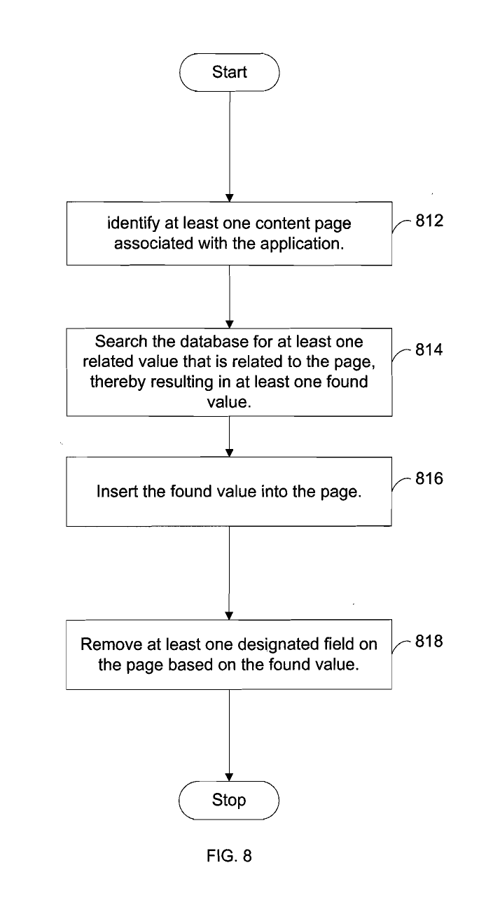

Referring to FIG. 8, in an exemplary embodiment, letting step 516 includes a step 812 of identifying at least one content page associated with the application, a step 814 of searching the database for at least one related value that is related to the page, thereby resulting in at least one found value, a step 816 of inserting the found value into the page, and a step 818 of removing at least one designated field on the page based on the found value. For example, the invention would pass content on a content page to preference-based content transformation algorithms of the invention. The invention would then identify the content page and search the preference database for preference values related to the page. If any preference values were found in the database, the invention would automatically insert them into the page. If the user had indicated that the user no longer wished to see certain fields on the page, then the invention would remove those fields from the content on the page.

### General

The present invention can take the form of an entirely hardware embodiment, an entirely software embodiment, or an embodiment containing both hardware and software elements. In an exemplary embodiment, the present invention is implemented in software, which includes but is not limited to firmware, resident software, and microcode.

Furthermore, the present invention can take the form of a computer program product accessible from a computer-usable or computer-readable medium providing program code for use by or in connection with a computer system or any instruction execution system. The computer program product includes the instructions that implement the method of the present invention. A computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random access memory (RAM), a read-only memory (ROM), a rigid magnetic disk, and an optical disk. Current examples of optical disks include compact disk—read only memory (CD-ROM), compact disk—read/write (CD-R/W), and DVD.

A computer system suitable for storing and/or executing program code includes at least one processor coupled directly or indirectly to memory elements through a system bus. The memory elements include local memory employed during actual execution of the program code, bulk storage, and cache memories that provide temporary storage of at least some program code to reduce the number of times code is retrieved from bulk storage during execution. Input/output (I/O) devices (including but not limited to keyboards, displays, pointing devices, etc.) can be coupled to the computer system either directly or through intervening I/O controllers. Network adapters may also be coupled to the computer system in order to enable the computer system to become coupled to other computer systems or remote printers or storage devices through intervening private or public networks. Modems, cable modems, and Ethernet cards are just a few of the currently available types of network adapters. The computer system can also include an operating system and a compute file-system.

### CONCLUSION

Having fully described a preferred embodiment of the invention and various alternatives, those skilled in the art will recognize, given the teachings herein, that numerous alternatives and equivalents exist which do not depart from the invention. It is therefore intended that the invention not be limited by the foregoing description, but only by the appended claims.

What is claimed is:

1. A processor-implemented method of customizing at least one computer software application for at least one user based on data associated with the user, comprising:
allowing the user to specify the data;
permitting the user to associate the data with at least one field in the application; and
letting the user change the structure of the application based on at least one preference value stored in at least one preference database.

2. The method of claim 1 wherein the allowing comprises allowing the user to set the value in the database.

3. The method of claim 2 wherein the allowing comprises allowing the user to set the value while interacting with at least one content page associated with the application.

4. The method of claim 2 wherein the allowing comprises allowing the user to set the value via an interface to a customization application in a customization system.

5. The method of claim 1 wherein the letting comprises:
identifying at least one content page associated with the application;
searching the database for at least one related value that is related to the page, thereby resulting in at least one found value;
inserting the found value into the page; and
removing the page based on the found value.

6. The method of claim 1 wherein the letting comprises:
identifying at least one content page associated with the application;
searching the database for at one least related value that is related to the page, thereby resulting in at least one found value;
inserting the found value into the page; and
splitting the page into at least two other content pages based on the found value.

7. The method of claim 1 wherein the letting comprises:
identifying at least one content page associated with the application;
searching the database for at least one related value that is related to the page, thereby resulting in at least one found value;
inserting the found value into the page; and
combining the page with at least one other content page based on the found value.

8. A processor-implemented method of customizing at least one computer software application for at least one user based on data associated with the user, comprising:
allowing the user to specify the data;
permitting the user to associate the data with at least one field in the application; and
letting the user change the content of the application based on at least one preference value stored in at least one preference database.

9. The method of claim 8 wherein the allowing comprises allowing the user to set the value in the database.

10. The method of claim 9 wherein the allowing comprises allowing the user to set the value while interacting with at least one content page associated with the application.

11. The method of claim 9 wherein the allowing comprises allowing the user to set the value via an interface to a customization application in a customization system.

12. The method of claim 8 wherein the permitting comprises permitting the user to make the application avoid displaying at least one field that is associated with the value.

13. The method of claim 8 wherein the letting comprises:
identifying at least one content page associated with the application;
searching the database for at least one related value that is related to the page, thereby resulting in at least one found value;
inserting the found value into the page; and
removing at least one designated field on the page based on the found value.

14. A processor-implemented system of customizing at least one computer software application for at least one user based on data associated with the user, comprising:
an allowing module configured to allow the user to specify the data;
a permitting module configured to permit the user to associate the data with at least one field in the application; and
a letting module configured to let the user change the structure of the application based on at least one preference value stored in at least one preference database.

15. The system of claim 14 wherein the allowing module comprises an allowing module configured to allow the user to set the value in the database.

16. The system of claim 15 wherein the allowing module comprises an allowing module configured to allow the user to set the value while interacting with at least one content page associated with the application.

17. The system of claim 15 wherein the allowing module comprises an allowing module configured to allow the user to set the value via an interface to a customization application in a customization system.

18. The system of claim 14 wherein the letting module comprises:
an identifying module configured to identify at least one content page associated with the application;
a searching module configured to search the database for at least one related value that is related to the page, thereby resulting in at least one found value;
an inserting module configured to insert the found value into the page; and
a removing module configured to remove the page based on the found value.

19. A processor-implemented system of customizing at least one computer software application for at least one user based on data associated with the user, comprising:
an allowing module configured to allow the user to specify the data;
a permitting module configured to permit the user to associate the data with at least one field in the application; and
a letting module configured to let the user change the content of the application based on at least one preference value stored in at least one preference database.

20. The system of claim 19 wherein the allowing module comprises an allowing module configured to allow the user to set the value in the database.

21. The system of claim 20 wherein the allowing module comprises an allowing module configured to allow the user to set the value while interacting with at least one content page associated with the application.

22. The system of claim 20 wherein the allowing module comprises an allowing module configured to allow allowing the user to set the value via an interface to a customization application in a customization system.

23. The system of claim 19 wherein the permitting module comprises a permitting module configured to permit the user to make the application avoid displaying at least one field that is associated with the value.

24. The system of claim 19 wherein the letting module comprises:
an identifying module configured to identify at least one content page associated with the application;
a searching module configured to search the database for at least one related value that is related to the page, thereby resulting in at least one found value;
an inserting module configured to insert the found value into the page; and
a removing module configured to remove at least one designated field on the page based on the found value.

25. A computer program product usable with a programmable computer having readable program code embodied therein of customizing at least one computer software application for at least one user based on data associated with the user, the computer program product comprising:
computer readable code for allowing the user to specify the data;
computer readable code for permitting the user to associate the data with at least one field in the application; and
computer readable code for letting the user change the structure of the application based on at least one preference value stored in at least one preference database.
